(19) United States
(12) Patent Application Publication
(10) Pub. No.: US 2018/0012154 A1
(43) Pub. Date: Jan. 11, 2018

(54) SYSTEMS, METHODS, AND APPARATUSES FOR SELECTING DELIVERY SERVICE FACILITY LOCATION

(71) Applicant: Wal-Mart Stores, Inc., Bentonville, AR (US)

(72) Inventor: Kerry D. Melton, Springdale, AR (US)

(21) Appl. No.: 15/637,722

(22) Filed: Jun. 29, 2017

Related U.S. Application Data
(60) Provisional application No. 62/358,253, filed on Jul. 5, 2016.

(51) Int. Cl. G06Q 10/04; G06Q 50/28

(52) U.S. Cl. CPC G06Q 10/04; G06Q 10/047; G06Q 50/28

(57) ABSTRACT

In some embodiments, apparatuses and methods are provided herein useful to delivery service facility location selection. In some embodiments, a system for delivery service facility location selection comprises an area information database, a node location database, and a control circuit configured to select one or more nodes as a recommended delivery service facility location by: assigning cost values to a plurality of items in the area information, associating area information with at least some nodes of the plurality of nodes based on the location information of the at least some nodes, determining an area cost value for each of the at least some nodes based on cost values associated with the plurality of items of the area information, determining a transportation cost value for each of the at least some nodes, and selecting a node from the at least some nodes as the recommended.

### CROSS-REFERENCE TO RELATED APPLICATION

This application claims the benefit of the following U.S. Provisional Application No. 62/358,253 filed Jul. 5, 2016, which is incorporated herein by reference in its entirety.

### TECHNICAL FIELD

This invention relates generally to delivery services.

### BACKGROUND

Some retailers offer home delivery services to customers. With home delivery services, customers can order items online or over the phone and have the items delivered to them.

### BRIEF DESCRIPTION OF THE DRAWINGS

Disclosed herein are embodiments of systems, apparatuses and methods pertaining delivery service facility location selection. This description includes drawings, wherein:

FIG. 1 is a block diagram in accordance with some embodiments.

FIG. 2 is a flow diagram in accordance with several embodiments.

FIG. 3 is a flow diagram in accordance with some embodiments.

FIG. 4 is an illustration of a region in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for delivery service facility location selection. In some embodiments, a system for delivery service facility location selection comprises an area information database storing area information for one or more areas of a geographical region, a node location database storing location information of a plurality of nodes, each node corresponding to a location in a transportation network in the geographical region, and a control circuit configured to select one or more nodes as a recommended delivery service facility location by: assigning cost values to a plurality of items in the area information, associating area information with at least some nodes of the plurality of nodes based on the location information of the at least some nodes, determining an area cost value for each of the at least some nodes based on cost values associated with the plurality of items of the area information, determining a transportation cost value for each of the at least some nodes, and selecting a node from the at least some nodes as the recommended delivery service facility.

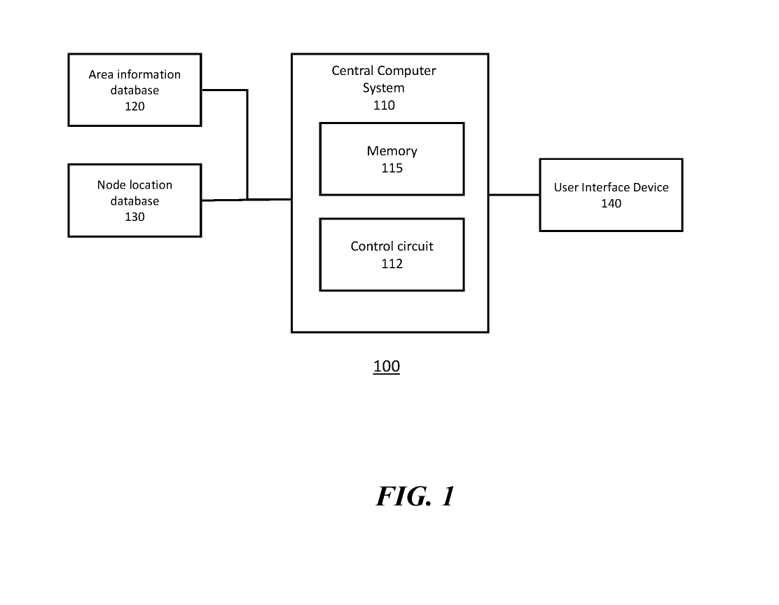

Referring first to FIG. 1, a block diagram of a system according to some embodiments is shown. The system 100 comprises a central computer system 110, an area information database 120, a node location database 130, and a user interface device 140.

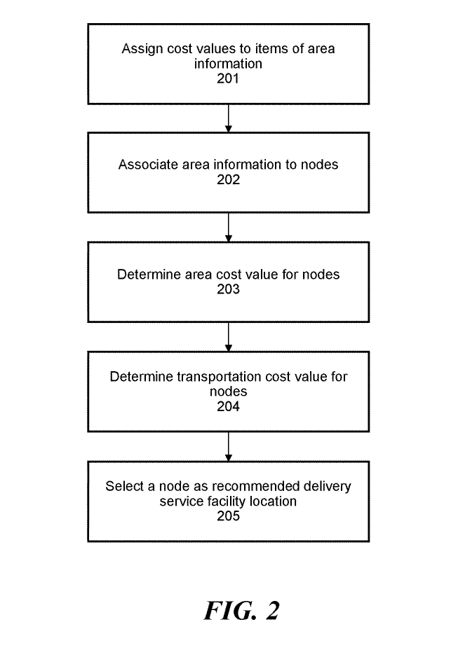

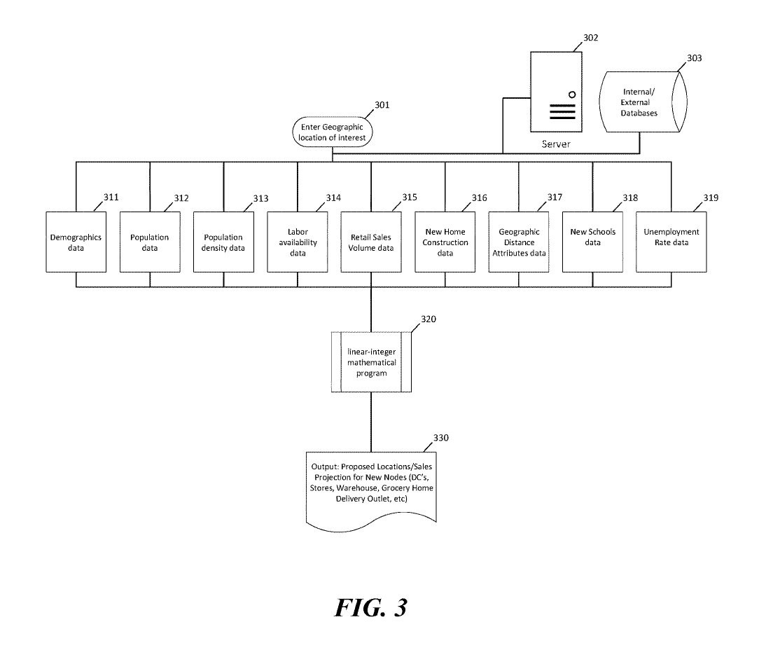

The central computer system 110 may comprise a processor-based system such as one or more of a server system, a computer system, a cloud-based server, a retail management system, and the like. The control circuit 112 may comprise a processor, a central processor unit, a microprocessor, and the like. The memory 115 may comprise one or more of a volatile and/or non-volatile computer readable memory devices. In some embodiments, the memory 115 stores computer executable codes that cause the control circuit 112 to provide a location selection tool to one or more user interface devices 140. In some embodiments, the memory 115 stores computer executable codes that cause the control circuit 112 to select one or more recommended delivery service facility location based on the information in the area information database 120 and the node location database 130 and display the recommendation via the user interface device 140. In some embodiments, a delivery service facility may comprise one or more of a store location providing home delivery service, a home delivery service fulfillment center, a storage/distribution facility supporting a facility providing home delivery service, and an inventory supply source for home delivery services. In some embodiments, the computer executable code stored in the memory 115 may cause the control circuit 112 to perform one or more steps described with reference to FIGS. 2-3 herein.

The central computer system 110 may be coupled to the area information database 120 and/or the node location database 130 via wired and/or wireless communication channels. The area information database 120 may be configured to store area information for a plurality of geographical areas. In some embodiments, area information may comprise one or more of demographic data, population data, population density data, labor availability data, retail sales volume data, new homes construction data, geographic distance attributes data, new school data, unemployment rate data, customer profiles, and the like. In some embodiments, each area information item may correspond to one or more geographic areas. In some embodiments, an area may correspond to a zip code, a city, a county, a neighborhood, a school district, a market area, a collection of blocks, etc. Generally, an area may comprise any defined geographic area sharing one or more characteristics. In some embodiments, an area may have located within it, one or more nodes. In some embodiments, the system 100 may be configured to retrieve and parse information from one or more sources such as government databases, public domain information, websites, studies, surveys, data service providers, networked databases, sales tracking systems, customer profile databases, and the like to periodically update the area information database 120. In some embodiments, at least some area information items may comprise public data and/or proprietary data collected by a retail operation associated with the system 100.

The node location database 130 may be configured to store location information for a plurality of nodes in a geographic region. In some embodiments, a node may correspond to a point and/or a collection of points in a transportation network. In some embodiments, a node may correspond to a road intersection and/or a collection of intersections in a transportation network. In some embodiments, a node may comprise a location that is available for setting up a delivery service facility and/or an existing retail facility (e.g. store, storage facility) not currently offering home delivery service. In some embodiments, the node location database 130 may store the locations of nodes relative to each other in a transportation network. In some embodiments, the node location database 130 may store information on routes between the nodes and one or more origin and destination points. For example, the node location database 130 may store a road map for a region and the locations of each node in the region on the road map. The road map may further comprise travel information such as travel distances, traffic conditions, and/or travel times for a plurality of segments of the roads on the map. Generally, the node location database 130 may store map information that allows the central computer system 110 to determine distance and/or travel costs between one or more of nodes, origin locations, and destination locations. In some embodiments, an origin location may refer to one or more locations from which items may be shipped to a node. In some embodiments, an origin point may correspond to the location of a distribution center, a storage facility, a store location, a fulfillment center, and the like. In some embodiments, a destination point may refer to one or more locations to which items may be shipped from a node if a delivery service facility is set up at the node. In some embodiments, a destination point may correspond to one or more of a store with delivery service, a delivery service facility, and one or more customer locations. In some embodiments, origin points and/or destination points may be located inside or outside of the region being considered for delivery service facility location.

While the area information database 120 and the node location database 130 are shown outside the central computer system 110 in FIG. 1, in some embodiments, the area information database 120 and the node location database 130 may be implemented as part of the central computer system 110 and/or the memory 115. In some embodiments, the area information database 120 and the node location database 130 may be implemented on one or more volatile and/or non-volatile computer readable memories. In some embodiments, the area information database 120 comprises database structures that correspond geographic areas to one or more area information items. In some embodiments, the node location database 130 comprises database structures that correspond nodes to locations on a map of a geographic region.

The user interface device 140 may comprise a processor-based device including one or more user input/output devices. In some embodiments, the user interface device 140 may comprise one or more of a desktop computer, a laptop computer, a mobile device, a portable device, a personal computer, a smartphone, a wearable device, etc. In some embodiments, the user interface device may comprise one or more of a display screen, a touch screen, a keyboard, a mouse, a motion tracking device, one or more buttons, and the like. In some embodiments, the user interface device 140 may be configured to provide the user interface of a delivery facility location selection tool to a user. In some embodiments, the user interface device 140 may be configured receive a selection of a region of interest from a user and provide a recommended location for delivery service facility in the selection region to the user via the user interface. In some embodiments, the location selection user interface may be configured receive the region of interest selection and display the recommended location via a graphical map interface. For example, the user interface may allow the user to enter a region descriptor (e.g. city name, county name, zip code(s), market identifier, etc.) and/or select a region on a map (e.g. draw boundaries, select one or more sections of the map) to enter a region of interest. In some embodiments, one or more recommended locations for delivery service facility may be displayed as locations on a map of the selected region. In some embodiments, the delivery facility location selection tool may comprise one or more of a computer program, a web-based user interface, a server-based user interface, a mobile application, and the like. In some embodiments, the delivery facility location selection tool may be provided by the central computer system 110 and/or be at least partially stored on a memory device on the user interface device 140. In some embodiments, the user interface device 140 may be implemented as part of the central computer system 110 and/or a standalone device.

Referring next to FIG. 2, a method for providing delivery service facility location selection according to some embodiments is shown. The steps in FIG. 2 may generally be performed by a processor-based device such as a central computer system, a server, a cloud-based server, a retail management system, etc. In some embodiments, the steps in FIG. 2 may be performed by one or more of the control circuit 112 and the user interface device 140 described with reference to FIG. 1 and server 302 described with reference to FIG. 3 herein.

In some embodiments, prior to step 201, a system may provide a delivery service facility location selection tool to a user via a user device such as the user interface device 140 described with reference to FIG. 1 herein. The user may enter a selection of a region to consider via the user interface of the tool. For example, a user may select one or more states, cities, counties, markets, zip codes, neighborhoods, districts, etc. (e.g. Denver, New Hampshire, North Dallas, etc.) to begin the process. In some embodiments, the user interface device may display a map in a graphical user interface, and the user may select boundaries of the region and/or one or more sections of the map to include in the region of interest via the graphical user interface.

In some embodiments, prior to step 201, the system may aggregate area information and node information from one or more external and/or internal sources. In some embodiments, the system may access data services, websites, government provided data, internal databases, published studies, surveys, sales history data, etc. to retrieve and parse various information items associated with areas to be evaluated. For example, the system may access government census data and convert the census data to area information items prior to storing them in the area information database.

In step 201, the system assigns cost values to a plurality of items in the area information. The area information items may be stored in an area information database such as the area information database 120 described in FIG. 1. In some embodiments, the plurality of items in the area information may comprise one or more of demographic data, population data, population density data, labor availability data, retail sales volume data, new homes construction data, geographic distance attributes data, new school data, unemployment rate data, and the like. In some embodiments, area cost value may comprise one or more of amortized fixed cost, real estate cost, unemployment cost, labor cost, penalty cost for a lack of growth area, and penalty cost for a lack of population. Area cost values may generally refer to values assigned to characteristics associated with are information data items. In some embodiments, the system may use one or more formulas specific to data item types to convert each data item to a cost value. For example, a first formula may be used to convert unemployment rate to an unemployment cost value and a different formula may be used to convert population density to a population density cost value. In some embodiments, the cost value may correspond to the information item's expected impact on the cost of operating a delivery service facility at the node. In some embodiments, the cost value may correspond to the information item's expected impact on potential home delivery sales. In some embodiments, cost values may be represented in currency amounts (e.g. dollar amount). In some embodiments, a score may be assigned based on the ranges associated with the information item. For example, a score may be assigned to different ranges of unemployment rate, population density level, household income level, etc. In some embodiments, the cost value may generally be assigned based on the expected reduction in revenue, whether through the cost of operation or lost in sales, associated the area information items.

In step 202, the system associates area information with at least some nodes of a plurality of nodes stored in a node location database. In some embodiments, nodes may comprise nodes stored in a node location database such as the node location database 130 described with reference to FIG. 1. In some embodiments, a node may correspond to a location in a transportation network in the geographical region. In some embodiments, prior to step 202, the system may cluster one or more nodes in proximity of each other into a single node for the purpose of selecting a delivery service facility. In some embodiments, prior to step 202, the system may first filter the nodes in the database based on one or more of location availability and existing facility locations to select nodes for consideration in step 202. In some embodiments, one or more filtering parameters may be provided to the user of the location selection user interface prior to step 202. In some embodiments, in step 202, the nodes are associated with area information based on the locations of the nodes stored in the node location database. In some embodiments, a node may be associated with area information of a geographic area in which the node is located. In some embodiments, area information associated with a node may comprise area information associated with different areas and/or a subset of areas. For example, a node may be associated with area information items associated with a city and a county in which it is located. In some embodiments, a node may further be associated with some area information items associated with nearby areas. For example, demographic information from a neighboring city may be associated with a node in a different city if the neighboring city may be expected to be served by a delivery facility location located at the node and/or provide labor and/or material to the delivery service facility location.

In step 203, the system determines area cost value for a plurality of nodes based on cost values associated with the plurality of items of the area information. In some embodiments, the area cost value for a node may be determined based on combining the cost values of each item of area information associated with the node. In some embodiments, one or more area information item cost values may be weighted when determining the area cost value for the node. For example, cost value associated with unemployment rate may be weighted more heavily as compared to the current sales volume of the area. In some embodiments, the weighting of the one or more items of area information may be configurable via a location recommendation tool provided to the user. In some embodiments, the tool may further allow users to remove one or more items of area information from the evaluation performed by the system. In some embodiments, the area cost value may be represented by one or more of an integer value, an estimated dollar amount, and a score. In step 203, the system may go through each node being considered and determine the area cost value for each node.

In step 204, the system determines a transportation cost value for each node being considered. In some embodiments, transportation cost value for a node may be determined based on travel distances from at least one origin location to one or more destination locations via each of the at least some nodes. In some embodiments, the transportation cost value may be determined based on one or more of driver wage, fuel cost, and trailer and truck maintenance cost associated with the route and/or the area of the node. In some embodiments, transportation cost value may further comprise toll costs. In some embodiments, the travel distances through the node may be converted to driver wage, fuel cost, and maintenance cost further based on area cost information.

In some embodiments, an origin location refers to one or more locations from which items may be shipped to the node and a destination point refers to one or more locations to which items may be shipped from the node if a delivery service facility is set up at the node. In some embodiments, an origin location may correspond to the location of a supplier, a distribution center, a storage facility, a store location, a fulfillment center, other delivery service facilities, and the like. In some embodiments, the destination location may correspond to other delivery service facilities and/or one or more customer locations. In some embodiments, origin points and/or destination points may be located inside or outside of the region being considered for delivery service location. In some embodiments, the system may only consider the transportation cost from origin locations to the node. In some embodiments, the system may estimate the transportation cost from the node to destination locations based selecting one or more representative locations (e.g. central location) for a cluster of expected delivery destinations. In some embodiments, the transportation cost value for a node may be represented by one or more of an integer value, an estimated dollar amount, and a score.

In step 205, the system selects a node as the recommended delivery service facility location. In some embodiments, the node is selected based on minimizing the area cost value and the transportation cost value associated with the node. In some embodiments, minimizing the area cost value comprises minimizing the sum of cost values associated the plurality of items in the area information. In some embodiments, the node is further selected based on the constraint of ensuring distribution flow through one or more nodes. In some embodiments, one or more nodes may be selected as recommended delivery service facility locations and displayed via a user interface. In some embodiments, the system may display the recommended delivery service facility location(s) on a map of the geographical region via a graphical user interface on a user interface device. For example, the recommended location may be displayed with a marker on a map of the region. In some embodiments, the system may further be configured to display a plurality of recommended facility locations. In some embodiments, the recommended facility locations may be ranked based on the area cost values and/or transportation cost values.

In some embodiments, the node may be selected as the recommended delivery service facility location based on linear integer programming. Integer programming problem refers a mathematical optimization or feasibility program in which some or all of the variables are restricted to be integers. Integer linear programming refers to a subset of integer programming in which the objective function and the constraints (other than the integer constraints) are linear. In some embodiments, minimizing the area cost value and the transportation cost value comprises an objective in the linear integer programming. In some embodiments, conservation of distribution flow through the node comprises a constraint in the linear integer programming. An example of linear integer programming for selecting a location for delivery service facility is provided herein.

Model Sets:
N—set of nodes in the network
A—set of arcs in the network
P—set of origin-destination pairs
P^{ij}—set of nodes on the path from origin i to destination j

Model Parameters:
dₖₗ^{ij}—distance from k to l on the path from i to j, for all (ij) ε P and k, l ε P^{ij} such that k<l; k<l means that ‘k’ is before ‘l’ on the path from i to j
cₖₗ^{ij}—distribution cost per mile from k to l on the path from i to j, for all (ij) ε P and k, l ε P^{ij} such that k<l; the cost includes distribution costs (e.g. driver wages, fuel costs, trailer and truck maintenance costs, etc.)
f^{ij}—annual truckload flow from i to j for all (ij) ε P
θ—length-of-haul limit for distribution
eₖ—annual amortized fixed cost (e.g. real estate taxes, building amortization, etc.) for setting up a node at k ε N
gₖ—annual unemployment cost for a node at k ε N
hₖ—annual labor cost for a node at k ε N
wₖ—annual penalty cost for a lack of growth area based on new home construction, number of schools being built, etc. for a node at k ε N
pₖ—penalty cost for a lack of population for a node at k ε N

Objective:
minimize

Σ_{(ij)ε P} f^{ij} Σ_{k,lε P}_{^{ij}}_{:k<l} cₖₗ^{ij} dₖₗ^{ij} yₖₗ^{ij}+ (1)

Σ_{kε N} eₖ zₖ+ (2)

Σ_{kε N} gₖ zₖ+ (3)

Σ_{kε N} hₖ zₖ+ (4)

Σ_{kε N} wₖ zₖ+ (5)

Σ_{kε N} pₖ zₖ (6)

### Where:

(1)—annual cost from k to l on the path from i to j, for all (ij) ε P and k, l ε P^{ij} such that k<l; the cost includes distribution costs (e.g. driver wages, fuel costs, trailer and truck maintenance costs, etc.)
(2) eₖ—annual amortized fixed cost (e.g. real estate taxes, building amortization, building set-up/property procurement costs, etc.) for setting up a node at k ε N
(3) gₖ—annual unemployment cost for a node at k ε N
(4) hₖ—annual labor cost for a node at k ε N
(5) wₖ—annual penalty cost for a lack of growth area based on new home construction, number of schools being built, etc. for a node at k ε N
(6) pₖ—penalty cost for a lack of population/population density for a node at k ε N

Constraints:

Σ_{lε P}_{^{ij}}_{:k<l, d}_{ₖₗ}_{^{ij}}_{≦θ} yₖₗ^{ij}=zₖ for all (ij) ε P and k ε P^{ij}\{i,j} (1)

Σ_{lε P}_{^{ij}}_{:l<k, d}_{ₗₖ}_{^{ij}}_{≦θ} yₗₖ^{ij}=zₖ for all (ij) ε P and k ε P^{ij}\{i,j} (2)

Σ_{l ε P}_{^{ij}}_{:l<j, d}_{ₗⱼ}_{^{ij}}_{≦θ} yₗⱼ^{ij}=1 for all (ij) ε P (3)

Σ_{l ε P}_{^{ij}}_{:i<l, d}_{ᵢₗ}_{^{ij}}_{≦θ} yᵢₗ^{ij}=1 for all (ij) ε P (4)

yₖₗ^{ij}ε{0,1} for all k, l ε P^{ij} and for all (ij) ε P (5)

zₖε{0,1} for all k; k ε N (6)

### Where:

(1) and (2) represent flow conservation for distribution flow (e.g. truck, rail, water, air transportation) into and out of each node, respectively
(3)—terminates distribution flow at destination (j) on the path from i to j
(4)—initiates distribution flow from the origin (i) on the path from i to j
(5) and (6) are the integrality constraints for the variables

The mode set, parameters, objectives, and constraints above are provided as examples only. The system may generally be configured to recommend a delivery service facility based on fewer or more parameters, objectives, and/or constraints. Generally, integer linear programming may be used to select a node from a plurality of nodes that minimizes cost values associated with a plurality of parameters.

In some embodiments, one or more variables and equations for calculating area cost values for each node may comprise a first set of rules. In some embodiments, one or more variables and equations for calculating transportation cost values for each node may comprise a second set of rules. In some embodiments, one or more of the objectives, constraints, and the minimizing of area cost value and transportation cost value ay comprise a third set of rules. The first, second, and third set of rules may comprise rules control the system's logic and behavior when the system automatically selects a recommended delivery service facility location in accordance with the systems and methods described herein.

In some embodiments, steps 201-205 may be repeated for the same region based on updated area information data and node location data. For example, when new area labor information becomes available, the system may repeat the evaluation of nodes and recommend a different location. In some embodiments, steps 201-205 may be performed for a plurality of regions to recommend delivery service facility locations for different regions. In some embodiments, steps 201-205 may further take into account existing delivery service facility and customers already being served by the existing facility. For example, area population density and area demographic information may exclude customers in areas already serviced by an existing facility. In some embodiments, existing delivery facilities may comprise origin points and/or destination points in the evaluation. In some embodiments, steps 201-205 may function to compare cost values for existing locations and potential locations and recommend the relocation of an existing delivery service facility.

Next referring to FIG. 3, a flow diagram of a process for selecting a location for delivery service facility is shown. The process may generally be performed with a server 302 coupled to one or more internal/external databases 303. The server 302 may comprise a processor-based device having a control circuit and a memory device. In some embodiments, the server 302 may comprise the central computer system 110 and/or the user interface device 140 described with FIG. 1 herein. In some embodiment, the internal/external databases 303 may comprise area information database 120, the node location database 130, and/or other databases.

In step 301, a user enters a geographic location of interest. In some embodiments, the system may receive a selection of a region/location via a user interface device such as the user interface device 140 described with reference to FIG. 1 herein. For example, a user may select one or more states, cities, counties, markets, zip codes, neighborhoods, districts, etc. (e.g. Denver, New Hampshire, North Dallas, etc.) to begin the process. In some embodiments, a map interface may be displayed and the user may define the search area using the map interface.

After step 301, the system retrieves a plurality of area information items for areas within the selected region. Area information items may comprise one or more of demographics data 311, population data 312, population density data 313, labor availability data 314, retail sales volume data 315, new home construction data 316, geographic distant attributes data 317, new school construction data 318, and unemployment data 319. In some embodiment, one or more of the information items may be based on government/public records such as census records, property records, building permit records, unemployment figures, news reports, etc. In some embodiments, one or more of the information items may be based on data services that aggregate data from public and/or private records. In some embodiments, one or more of the information items may be at least partially based on a retail operation's internal records such as sales, wage, hiring, and customer survey records.

In step 320, one or more of the area information items are used as parameters in a linear integer mathematical program. The linear integer mathematical program may be configured to compare a plurality of nodes to select a node as the recommended delivery service facility location. In some embodiments, one or more of the area information items may be associated with a cost value and minimizing the total cost value for the selected node may comprise the objective of the linear integer mathematical program. In some embodiments, one or more of the area information items may be weighed against each other in determining the total cost value for the nodes. In some embodiments, the integer mathematical program may select a node based on minimizing the area cost value and a transportation cost value associated with a node. In some embodiments, the transportation cost value may be determined based on the distances of travel between one or more origin locations and one or more destination locations via the node. In some embodiments, the transportation cost value may further be based on fuel cost, driver wage, and vehicle maintenance cost associated with the area. In some embodiments, the linear integer mathematical program may further comprise constraints for selecting a node. In some embodiments, one or more constraints may comprise conservation of distribution flow through the node.

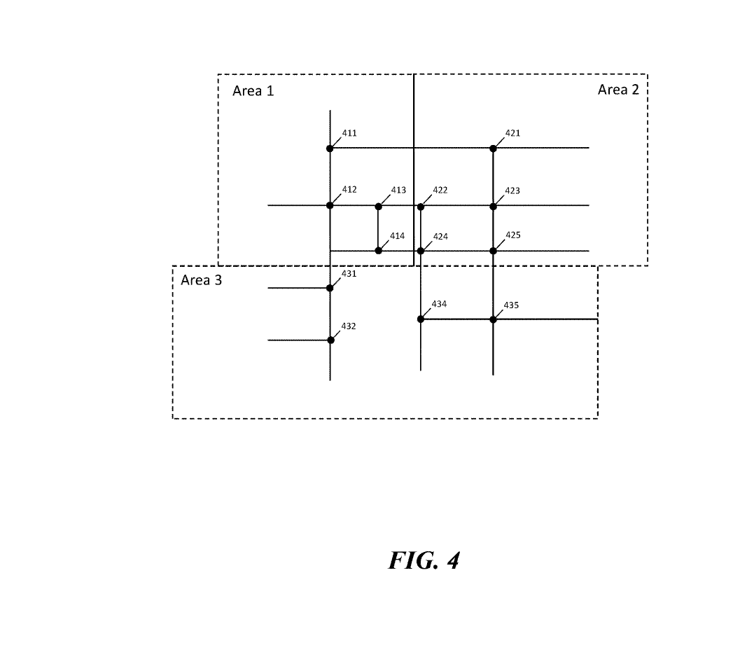

Next referring to FIG. 4, an illustration of a region is shown. The region comprises three areas—area 1, area 2, and area 3, and nodes 411-414, 421-425, and 431-435. Lines in FIG. 3 represent roads and circles represent nodes in the transportation network comprising the roads. While the nodes are illustrated to be on intersections, a node could be located anywhere along at least one road.

In some embodiments, when the region shown in FIG. 4 is considered for delivery service facility locations, the system may consider cost values associated with one or more of the nodes 411-414, 421-425, and 431-435. In some embodiments, one or more of the nodes may be clusters for consideration, for example, nodes 412-414 may be considered to be one node by the system during the evaluation. For each node considered, the system may associate the node with area information of the area in which the node is located. For example, 411-414, 421-425, and 431-435 may be associated with the area information items associated with area 1, area 2 and area 3 respectively. In some embodiments, some area information items may be associated with larger areas. For example, some area information items may be shared by nodes in two or more of areas 1-3. The system may then assign cost values to one or more items of area information such as demographic data, population data, population density data, labor availability data, retail sales volume data, new homes construction data, geographic distance attributes data, new school data, unemployment rate data, and the like. The system may further determine transportation costs for each node. In some embodiments, the transportation cost may comprise the transportation cost from one or more origin locations to the node and/or from the node to one or more destination locations. Origin locations and destination locations may comprise one or more of: nodes in the region, locations outside of the region, and/or other locations expected to serve and/or be served by a delivery service facility located at the node. For example, if a cluster of potential customers of the delivery service is located near node 435, transportation cost may be calculated based in part on the transportation cost from each node to node 435.

Provided below, is an example set of data used in selecting a delivery facility for routing inventory from two origin-destination pairs (Birmingham, Ala. to Santa Fe, N. Mex., and Luling La. to Foxfield, Colo.). Table 1 shows a listing of nodes considered for delivery facility location and area cost values for items of area information—real estate cost, unemployment percentage, hourly labor cost, penalty cost for lack of growth, and penalty cost for lack of population. Table 2A-D shows the link distances and cost per miles along four routes between the origin and destination pairs.

TABLE 1
Nodes area information

| | Real Estate | | Hourly | Lack of | Penalty Cost |
|---|---|---|---|---|---|
| | Cost | Unemployment | Labor | Growth | for Lack of |
| Potential Location | (per acre) | % | Cost | Penalty Cost | Population |
| AL/MS STATE LINE | $2,301 | 10.0% | $12.82 | $32,100 | $82,846 |
| AR/OK STATE LINE | $1,205 | 5.0% | $8.70 | $11,800 | $58,679 |
| BALD KNOB, AR | $5,928 | 2.0% | $11.02 | $48,100 | $90,137 |
| BINGER, OK | $2,379 | 2.0% | $8.41 | $10,800 | $48,418 |
| CLINES CNRS, NM | $2,244 | 1.0% | $9.12 | $44,000 | $77,120 |
| CONWAY, AR | $2,423 | 8.0% | $12.67 | $34,600 | $69,938 |
| E OF BINGER, OK | $3,718 | 7.0% | $15.99 | $37,800 | $33,521 |
| E OF BOYCE, LA | $2,836 | 4.0% | $15.42 | $21,100 | $78,241 |
| E OF FLOURNOY, LA | $3,175 | 5.0% | $13.36 | $36,900 | $71,687 |
| E OF LIMON, CO | $2,479 | 5.0% | $9.19 | $17,200 | $88,559 |
| E OF MEMPHIS, TN | $4,197 | 7.0% | $15.28 | $38,600 | $93,441 |
| E OF OKLAUNION, TX | $3,892 | 7.0% | $10.63 | $33,300 | $83,793 |
| E OF SALLISAW, OK | $2,728 | 3.0% | $10.46 | $41,900 | $96,591 |
| E OF SAYRE, OK | $5,346 | 9.0% | $10.92 | $38,300 | $80,711 |
| E OF SHAMROCK, TX | $4,830 | 1.0% | $12.23 | $20,600 | $25,908 |
| E OF VEGA, TX | $5,300 | 7.0% | $11.41 | $27,400 | $49,070 |
| E OF WICHITA | $5,628 | 6.0% | $12.58 | $28,800 | $25,450 |
| FLS, TX | | | | | |
| FOXFIELD, CO | $4,514 | 5.0% | $13.73 | $24,300 | $39,752 |
| FRANKTOWN, CO | $3,629 | 9.0% | $8.32 | $20,500 | $70,872 |
| GREENVILLE, TX | $2,255 | 6.0% | $11.85 | $12,100 | $83,143 |
| IOWA PK, TX | $5,400 | 3.0% | $15.74 | $46,600 | $97,919 |
| KS/CO STATE LINE | $4,580 | 6.0% | $11.24 | $35,900 | $44,247 |
| LA/TX STATE LINE | $5,074 | 6.0% | $9.14 | $24,300 | $40,031 |
| LAWRENCE, TX | $3,778 | 6.0% | $13.40 | $14,600 | $12,650 |
| MINEOLA, TX | $2,962 | 2.0% | $11.68 | $48,500 | $34,730 |
| MS/TN STATE LINE | $2,645 | 6.0% | $14.92 | $13,500 | $23,197 |
| N OF LAFAYETTE, LA | $5,192 | 4.0% | $12.56 | $30,200 | $62,685 |
| N OF LAMAR, CO | $3,358 | 8.0% | $8.96 | $34,000 | $42,526 |
| N OF MINCO, OK | $3,421 | 5.0% | $14.39 | $16,100 | $52,244 |
| N OF PARKER, CO | $2,616 | 9.0% | $12.73 | $12,600 | $45,677 |
| NE OF AMARILLO, TX | $4,860 | 8.0% | $15.39 | $11,000 | $83,294 |
| NE OF MIDLAND | $3,874 | 6.0% | $15.59 | $21,700 | $71,626 |
| PK, KS | | | | | |
| NW OF FORBING, LA | $5,701 | 8.0% | $11.31 | $20,700 | $16,018 |
| NW OF FRELLSEN, LA | $5,781 | 4.0% | $15.14 | $41,000 | $67,368 |
| NW OF IOWA PK, TX | $2,363 | 10.0% | $14.46 | $10,800 | $64,157 |
| NW OF MESQUITE, TX | $4,017 | 1.0% | $11.09 | $22,600 | $32,583 |
| NW OF RVR BND, CO | $2,849 | 8.0% | $15.65 | $30,100 | $68,630 |
| OK/CO STATE LINE | $5,715 | 6.0% | $12.30 | $15,600 | $32,329 |
| OK/KS STATE LINE | $2,483 | 7.0% | $8.05 | $36,900 | $26,015 |
| OK/TX STATE LINE | $3,216 | 8.0% | $14.14 | $29,300 | $52,712 |
| S OF DENTON, TX | $2,551 | 2.0% | $15.99 | $40,400 | $10,323 |
| S OF FARMERS | $3,215 | 7.0% | $10.93 | $19,000 | $40,383 |
| BRCH, TX | | | | | |
| S OF FLOURNOY, LA | $5,960 | 1.0% | $15.59 | $45,700 | $53,064 |
| S OF MARION, AR | $2,955 | 6.0% | $11.77 | $10,900 | $43,124 |
| S OF MEMPHIS, TN | $4,851 | 1.0% | $9.99 | $32,000 | $97,450 |
| S OF MESA, AD, CO | $2,907 | 2.0% | $11.12 | $42,000 | $47,998 |
| S OF SAYRE, AL | $3,820 | 10.0% | $13.81 | $48,600 | $91,737 |
| S OF SNTA FE, NM | $3,327 | 4.0% | $15.05 | $36,000 | $79,273 |
| SE OF | $3,862 | 6.0% | $9.94 | $20,000 | $40,645 |
| ALEXANDRIA, LA | | | | | |
| SE CANADA DE LOS | $5,850 | 7.0% | $8.63 | $44,500 | $57,139 |
| ALAM, NM | | | | | |
| SE OF HOLLY | $5,431 | 3.0% | $9.30 | $36,500 | $57,848 |
| SPRS, MS | | | | | |
| SE OF MEMPHIS, TN | $4,894 | 3.0% | $12.89 | $47,200 | $55,793 |
| SE OF | $4,911 | 2.0% | $11.90 | $39,700 | $17,714 |
| SCOTLANDVILLE, LA | | | | | |
| SNTA FE, NM | $2,660 | 4.0% | $12.59 | $28,600 | $23,448 |
| SW OF OKLAHOMA | $2,619 | 4.0% | $12.02 | $17,400 | $27,220 |
| CY, OK | | | | | |
| SW OF ROLAND, OK | $4,736 | 5.0% | $11.75 | $25,800 | $53,178 |
| SW OF TERRELL, TX | $4,702 | 6.0% | $12.51 | $19,500 | $19,614 |
| SW OF WOODS, OK | $4,039 | 4.0% | $10.17 | $12,500 | $16,213 |
| TN/AR STAE LINE | $2,079 | 9.0% | $9.00 | $18,000 | $11,031 |
| TX/NM STATE LINE | $3,984 | 5.0% | $15.67 | $10,600 | $57,600 |
| TX/OK STATE LINE | $4,583 | 3.0% | $13.90 | $14,000 | $86,124 |
| UNION CY, OK | $5,154 | 6.0% | $14.13 | $34,600 | $94,491 |
| W OF | $5,280 | 2.0% | $12.68 | $17,300 | $35,417 |
| BIRMINGHAM, AL | | | | | |
| W OF DECATUR, TX | $3,314 | 10.0% | $8.44 | $32,800 | $15,581 |
| W OF FORBING, LA | $2,852 | 2.0% | $12.30 | $48,600 | $48,497 |
| W OF FRELLSEN, LA | $3,151 | 4.0% | $11.90 | $48,600 | $23,448 |
| W OF HICKORY | $3,083 | 4.0% | $12.59 | $48,600 | $27,220 |
| FLT, MS | | | | | |
| W OF JONESVILLE, TX | $3,397 | 5.0% | $12.02 | $36,000 | $53,178 |
| W OF KENSETT, AR | $2,683 | 6.0% | $11.75 | $20,000 | $19,614 |
| W OF KROTZ SPRS, LA | $2,694 | 4.0% | $12.51 | $44,500 | $16,213 |
| W OF LULING, LA | $3,476 | 9.0% | $10.17 | $36,500 | $11,031 |
| W OF MARION, AR | $3,735 | 5.0% | $9.00 | $47,200 | $57,600 |
| W OF | $3,123 | 3.0% | $15.67 | $39,700 | $86,124 |
| OKLAUNION, TX | | | | | |
| W OF SALINA, KS | $2,189 | 6.0% | $13.90 | $28,600 | $94,491 |
| W OF SHAMROCK, TX | $2,198 | 2.0% | $14.13 | $17,400 | $35,417 |
| W OF VEGA, TX | $2,069 | 10.0% | $12.68 | $25,800 | $15,581 |
| W OF WASHBURN, TX | $3,281 | 10.0% | $8.44 | $25,800 | $48,497 |
| W OF WILEY, CO | $3,471 | 8.0% | $12.30 | $36,500 | $86,124 |
| WILLOW GLN, LA | $2,611 | 9.0% | $12.30 | $47,200 | $94,491 |
| E OF AMARILLO, TX | $1,205 | 5.0% | $8.70 | $11,800 | $18,155 |

TABLE 2A
Transportation cost along path 1 between Birmingham, AL and Santa
Fe, NM

| | Cumulative | Link Distance | |
|---|---|---|---|
| Highway Links | Distance (miles) | (miles) | $ per Mile |
| W OF BIRMINGHAM, AL | 1 | 1 | $2.33 |
| W OF BIRMINGHAM, AL | 2 | 1 | $1.63 |
| W OF BIRMINGHAM, AL | 4 | 2 | $2.48 |
| S OF SAYRE, AL | 15 | 11 | $3.00 |
| AL/MS STATE LINE | 99 | 84 | $1.38 |
| MS/TN STATE LINE | 217 | 118 | $2.07 |
| SE OF MEMPHIS, TN | 225 | 8 | $2.07 |
| S OF MEMPHIS, TN | 229 | 4 | $1.69 |
| TN/AR STATE LINE | 235 | 6 | $2.41 |
| S OF MARION, AR | 242 | 7 | $2.11 |
| AR/OK STATE LINE | 520 | 278 | $2.36 |
| OK/TX STATE LINE | 850 | 330 | $2.37 |
| TX/NM STATE LINE | 1027 | 177 | $2.52 |
| CLINES CNRS, NM | 1183 | 156 | $1.17 |
| SE OF CANADA DE LOS | 1224 | 41 | $2.60 |
| ALAM, NM | | | |
| S OF SNTA FE, NM | 1232 | 8 | $1.14 |
| SNTA FE, NM | 1234 | 2 | $2.41 |

TABLE 2B
Transportation cost along path 2 between Birmingham, AL and Santa
Fe, NM

| | Cumulative | Link Distance | |
|---|---|---|---|
| Highway Links | Distance (miles) | (miles) | $ per Mile |
| W OF BIRMINGHAM, AL | 1 | 1 | $2.31 |
| W OF BIRMINGHAM, AL | 2 | 1 | $1.73 |
| W OF BIRMINGHAM, AL | 4 | 2 | $1.12 |
| S OF SAYRE, AL | 15 | 11 | $1.68 |
| AL/MS STATE LINE | 99 | 84 | $2.72 |
| W OF HICKORY FLT, MS | 169 | 70 | $2.25 |
| SE OF HOLLY SPRS, MS | 184 | 15 | $1.22 |
| MS/TN STATE LINE | 217 | 33 | $1.66 |
| SE OF MEMPHIS, TN | 230 | 13 | $2.47 |
| E OF MEMPHIS, TN | 231 | 1 | $2.71 |
| TN/AR STATE LINE | 234 | 3 | $1.53 |
| S OF MARION, AR | 241 | 7 | $1.64 |
| W OF MARION, AR | 244 | 3 | $1.15 |
| BALD KNOB, AR | 326 | 82 | $1.19 |
| W OF KENSETT, AR | 337 | 11 | $2.21 |
| CONWAY, AR | 384 | 47 | $2.03 |
| AR/OK STATE LINE | 511 | 127 | $2.80 |
| SW OF ROLAND, OK | 517 | 6 | $2.85 |
| E OF SALLISAW, OK | 531 | 14 | $1.19 |
| SW OF WOODS, OK | 677 | 146 | $1.19 |
| SW OF OKLAHOMA CY, OK | 693 | 16 | $2.26 |
| SW OF OKLAHOMA CY, OK | 695 | 2 | $2.15 |
| UNION CY, OK | 717 | 22 | $2.46 |
| N OF MINCO, OK | 721 | 4 | $2.38 |
| E OF BINGER, OK | 741 | 20 | $1.27 |
| BINGER, OK | 745 | 4 | $2.75 |
| E OF SAYRE, OK | 818 | 73 | $1.84 |
| OK/TX STATE LINE | 841 | 23 | $2.77 |
| E OF SHAMROCK, TX | 854 | 13 | $2.07 |
| W OF SHAMROCK, TX | 857 | 3 | $1.56 |
| E OF VEGA, TX | 980 | 123 | $1.77 |
| W OF VEGA, TX | 983 | 3 | $2.96 |
| TX/NM STATE LINE | 1018 | 35 | $1.28 |
| CLINES CNRS, NM | 1173 | 155 | $2.28 |
| SE OF CANADA DE LOS | 1215 | 42 | $1.96 |
| ALAM, NM | | | |
| S OF SNTA FE, NM | 1223 | 8 | $2.41 |
| SNTA FE, NM | 1224 | 1 | $1.63 |

TABLE 2C
Transportation cost along path 3 between Luling, LA and Foxfield,
CO.

| | Cumulative | Link Distance | |
|---|---|---|---|
| Highway Links | Distance (miles) | (miles) | $ per Mile |
| W OF LULING, LA | 1 | 1 | $1.34 |
| NW OF FRELLSEN, LA | 8 | 7 | $2.12 |
| N OF LAFAYETTE, LA | 125 | 117 | $2.95 |
| NW OF FORBING, LA | 327 | 202 | $1.99 |
| E OF FLOURNOY, LA | 335 | 8 | $1.64 |
| LA/TX STATE LINE | 346 | 11 | $2.04 |
| SW OF TERRELL, TX | 483 | 137 | $2.59 |
| LAWRENCE, TX | 486 | 3 | $2.10 |
| NW OF MESQUITE, TX | 503 | 17 | $2.11 |
| S OF FARMERS BRCH, TX | 524 | 21 | $2.33 |
| S OF DENTON, TX | 552 | 28 | $2.62 |
| TX/OK STATE LINE | 588 | 36 | $2.00 |
| OK/KS STATE LINE | 825 | 237 | $2.49 |
| NE OF MIDLAND PK, KS | 867 | 42 | $2.73 |
| W OF SALINA, KS | 963 | 96 | $2.87 |
| KS/CO STATE LINE | 1214 | 251 | $2.31 |
| S OF MESA, AD, CO | 1374 | 160 | $1.16 |
| N OF PARKER, CO | 1389 | 15 | $1.33 |
| FOXFIELD, CO | 1393 | 4 | $1.07 |

TABLE 2D
Transportation cost along path 4 between Luling, LA and Foxfield,
CO.

| | Cumulative | Link Distance | $ per |
|---|---|---|---|
| Highway Links | Distance (miles) | (miles) | Mile |
| W OF LULING, LA | 1 | 1 | $2.04 |
| W OF FRELLSEN, LA | 5 | 4 | $1.51 |
| SE OF SCOTLANDVILLE, LA | 73 | 68 | $2.21 |
| W OF KROTZ SPRS, LA | 113 | 40 | $2.08 |
| WILLOW GLN, LA | 176 | 63 | $2.09 |
| SE OF ALEXANDRIA, LA | 180 | 4 | $2.56 |
| SE OF ALEXANDRIA, LA | 180 | 0 | $1.27 |
| E OF BOYCE, LA | 194 | 14 | $1.16 |
| W OF FORBING, LA | 295 | 101 | $2.68 |
| S OF FLOURNOY, LA | 306 | 11 | $2.20 |
| LA/TX STATE LINE | 314 | 8 | $2.08 |
| W OF JONESVILLE, TX | 322 | 8 | $2.43 |
| MINEOLA, TX | 403 | 81 | $2.15 |
| GREENVILLE, TX | 455 | 52 | $1.92 |
| W OF DECATUR, TX | 542 | 87 | $2.28 |
| E OF WICHITA FLS, TX | 609 | 67 | $1.24 |
| IOWA PK, TX | 625 | 16 | $2.59 |
| NW OF IOWA PK, TX | 627 | 2 | $1.66 |
| E OF OKLAUNION, TX | 655 | 28 | $1.43 |
| W OF OKLAUNION, TX | 657 | 2 | $1.01 |
| W OF WASHBURN, TX | 829 | 172 | $2.54 |
| E OF AMARILLO, TX | 835 | 6 | $1.68 |
| NE OF AMARILLO, TX | 837 | 2 | $1.94 |
| TX/OK STATE LINE | 934 | 97 | $2.65 |
| OK/CO STATE LINE | 975 | 41 | $1.22 |
| N OF LAMAR, CO | 1055 | 80 | $2.74 |
| W OF WILEY, CO | 1064 | 9 | $2.72 |
| E OF LIMON, CO | 1169 | 105 | $1.33 |
| NW OF RVR BND, CO | 1179 | 10 | $1.31 |
| FRANKTOWN, CO | 1232 | 53 | $1.22 |
| FOXFIELD, CO | 1246 | 14 | $1.99 |

With the data set above, minimizing transportation cost values and area cost values while maintaining distribution flow through the nodes yields Amarillo, Tex. as the recommended delivery service facility location. In some embodiment, the result may be obtained via the linear programming described with reference to step 204 of FIG. 2 herein.

The data and result above are provided as an example only. The data may not necessarily reflect real-world data. Additionally, with different data set and/or different weighting/processing or the data, different results may be obtained for the same origin-destinations pairs described above. In some embodiments, the systems and methods described herein may be used to select a delivery service facility location on larger or smaller scales. For example, similar determinations may be made with the origin, destination, and node locations within a state, a county, a region, a market, etc. In some embodiments, the determination may base on fewer or more origin and destination locations and/or pairs. While this example corresponds to the selection of a mid-route facility, in some embodiments, similar methods may also be used to select other types of delivery service facilities such as regional distribution centers, facilities for delivering directly customers in the area, and/or stores providing home delivery service.

A retail entity may operate some store locations that provide a grocery home delivery option and some that do not. Sometimes, a store may be newly assigned as a grocery home delivery store based on the demand in an already established market as to relieve the burden of an existing delivery store. For example, an existing store may transfer some delivery zip codes to another store based on demand volume. In some aspects, the conventional approach may not proactively consider what other store(s) should be opened or closed for grocery home delivery based on market attributes. The conventional approach also may not provide a methodology for determining what future markets should be considered for grocery home delivery.

A retail entity operating multiple stores may assign some stores as supply stores to provide grocery home delivery in various markets (e.g. Denver, San Jose) while some stores may discontinue grocery home delivery. In some embodiments, systems and methods described herein utilize linear integer programming to strategically plan which stores or store clusters should provide grocery home delivery and/or where a node should be created to provide an inventory supply source for grocery home delivery.

In some embodiment, a tool based on linear integer programming may be used to determine store(s) or store clusters that should be opened or not opened for grocery home delivery in both established and non-established or future markets. The systems and methods described herein use an analytic approach to consider where grocery home delivery supply nodes should be located while including critical data attributes such as one or more of: demographics, population, population density, labor availability, retail sales volume, new home construction, distance attributes (e.g. average distance between homes, distance from a store or node to housing markets), number of incremental schools being built, unemployment rates, etc. This tool may also help determine and plan future markets that do not currently provide a grocery home delivery program. Additionally, the linear integer program-based tool may determine where a new node should be located and/or built to serve as a supply source (i.e. store, distribution center, warehouse, etc.).

In some embodiments, an analytical approach to the selection of grocery home delivery supply nodes provides a more objective and less subjective result. The location selection tool may use linear integer programming with relevant objective and critical constraints. In some embodiments, real-world demographics and analytics data may be used as parameters of the program to determine where a supply node(s) should be located. In some embodiments, the tool may provide the flexibility to include many attribute variables in determining where a variety of node types should be located.

In some embodiments, a system for delivery service facility location selection comprises an area information database storing area information for one or more areas of a geographical region, a node location database storing location information of a plurality of nodes, each node corresponding to a location in a transportation network in the geographical region, and a control circuit configured to select one or more nodes as a recommended delivery service facility location by: assigning cost values to a plurality of items in the area information, associating area information with at least some nodes of the plurality of nodes based on the location information of the at least some nodes, determining an area cost value for each of the at least some nodes based on cost values associated with the plurality of items of the area information based on a first set of rules, determining a transportation cost value for each of the at least some nodes based on a second set of rules, and selecting a node from the at least some nodes as the recommended delivery service facility using linear programming according to a third set of rules.

In some embodiments, a method for delivery service facility location selection comprises: retrieving area information for one or more areas of the geographical region from an area information database, retrieving location information of a plurality of nodes from a node location database, each node corresponding to a location in a transportation network in the geographical region, assigning cost values to a plurality of items of area information, associating area information with at least some nodes of a plurality of nodes based on location information of the at least some nodes, determining an area cost value for each of the at least some nodes based on cost values associated with the plurality of items of the area information based on a first set of rules, determining a transportation cost value for each of the at least some nodes based on a second set of rules, and selecting a node from the at least some nodes as a recommended delivery service facility location based on minimizing the area cost value and the transportation cost value using linear programming according to a third set of rules.

In some embodiments, an apparatus for delivery service facility location selection comprises a non-transitory storage medium storing a set of computer-readable instructions, and a control circuit configured to execute the set of computer readable instructions which causes to the control circuit to: retrieve area information for one or more areas of the geographical region from an area information database, retrieve location information of a plurality of nodes from a node location database, each node corresponding to a location in a transportation network in the geographical region, assign cost values to a plurality of items of area information, associate area information with at least some nodes of a plurality of nodes based on location information of the at least some nodes, determine an area cost value for each of the at least some nodes based on cost values associated with the plurality of items of the area information based on a first set of rules, determine a transportation cost value for each of the at least some nodes based on a second set of rules, and select a node from the at least some nodes as a recommended delivery service facility location based on minimizing the area cost value and the transportation cost value using linear programming according to a third set of rules.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for delivery service facility location selection comprising:
an area information database storing area information for one or more areas of a geographical region;
a node location database storing location information of a plurality of nodes, each node corresponding to a location in a transportation network in the geographical region; and
a control circuit configured to select one or more nodes as a recommended delivery service facility location by:
assigning cost values to a plurality of items of the area information;
associate area information with at least some nodes of the plurality of nodes based on the location information of the at least some nodes;
determining an area cost value for each of the at least some nodes based on cost values associated with the plurality of items of the area information based on a first set of rules;
determining a transportation cost value for each of the at least some nodes based on a second set of rules; and
selecting a node from the at least some nodes as the recommended delivery service facility location based on minimizing the area cost value and the transportation cost value using linear programming according to a third set of rules.

2. The system of claim 1, wherein the plurality of items in the area information comprises one or more of demographic data, population data, population density data, labor availability data, retail sales volume data, new homes construction data, geographic distance attributes data, new school data, and unemployment rate data.

3. The system of claim 1, wherein the area cost value comprises one or more of amortized fixed cost, real estate cost, unemployment cost, labor cost, penalty cost for a lack of growth area, and penalty cost for a lack of population.

4. The system of claim 1, wherein minimizing the area cost value comprises minimizing a sum of cost values associated the plurality of items in the area information.

5. The system of claim 1, wherein the transportation cost value of the at least some nodes is determined based travel distances from at least one origin location to one or more destination locations via each of the at least some nodes.

6. The system of claim 1, wherein the transportation cost value comprises one or more of driver wage, fuel cost, and trailer and truck maintenance cost.

7. The system of claim 1, wherein the selecting of the node as the recommended delivery service facility location is based applying objectives and constrains in linear integer programming.

8. The system of claim 7, wherein minimizing the area cost value and the transportation cost value comprises an objective in the linear integer programming.

9. The system of claim 7, wherein a conservation of distribution flow through the node comprises a constraint in the linear integer programming.

10. The system of claim 1, wherein the control circuit is further configured to display the recommended delivery service facility location on a map of the geographical region via a graphical user interface.

11. A method for delivery service facility location selection comprising:
retrieving, at a control circuit, area information for one or more areas of a geographical region from an area information database;
retrieving, at the control circuit, location information of a plurality of nodes from a node location database, each node corresponding to a location in a transportation network in the geographical region;
assigning cost values to a plurality of items of area information;
associating area information with at least some nodes of the plurality of nodes based on the location information of the at least some nodes;
determining, with the control circuit, an area cost value for each of the at least some nodes based on cost values associated with the plurality of items of the area information based on a first set of rules;
determining, with the control circuit, a transportation cost value for each of the at least some nodes based on a second set of rules; and
selecting, with the control circuit, a node from the at least some nodes as a recommended delivery service facility location based on minimizing the area cost value and the transportation cost value using linear programming according to a third set of rules.

12. The method of claim 11, wherein the plurality of items in the area information comprises one or more of demographic data, population data, population density data, labor availability data, retail sales volume data, new homes construction data, geographic distance attributes data, new school data, and unemployment rate data.

13. The method of claim 11, wherein the area cost value comprises one or more of amortized fixed cost, real estate cost, unemployment cost, labor cost, penalty cost for a lack of growth area, and penalty cost for a lack of population.

14. The method of claim 11, wherein minimizing the area cost value comprises minimizing a sum of cost values associated the plurality of items in the area information.

15. The method of claim 11, wherein the transportation cost value of the at least some nodes are determined based travel distances from at least one origin location to one or more destination locations via each of the at least some nodes.

16. The method of claim 11, wherein the transportation cost value comprises one or more of driver wage, fuel cost, and trailer and truck maintenance cost.

17. The method of claim 11, wherein the selecting of the node as the recommended delivery service facility location is based on applying objectives and constrains in linear integer programming.

18. The method of claim 17, wherein minimizing the area cost value and the transportation cost value comprises an objective in the linear integer programming.

19. The method of claim 17, wherein a conservation of distribution flow through the node comprise a constraint in the linear integer programming.

20. The method of claim 11, further comprising: displaying the recommended delivery service facility location on a map of the geographical region via a graphical user interface.

21. An apparatus for delivery service facility location selection comprising:
a non-transitory storage medium storing a set of computer readable instructions; and
a control circuit configured to execute the set of computer readable instructions which causes to the control circuit to:
retrieve area information for one or more areas of a geographical region from an area information database;
retrieve location information of a plurality of nodes from a node location database, each node corresponding to a location in a transportation network in the geographical region;
assign cost values to a plurality of items of area information;
associate items of area information with at least some nodes of the plurality of nodes based on the location information of the at least some nodes;
determine an area cost value for each of the at least some nodes based on cost values associated with the plurality of items of the area information based on a first set of rules;
determine a transportation cost value for each of the at least some nodes based on a first set of rules; and
select a node from the at least some nodes as a recommended delivery service facility location based on minimizing the area cost value and the transportation cost value using linear programming according to a third set of rules.
